(19) United States
(12) Patent Application Publication
(10) Pub. No.: US 2014/0214643 A1
(43) Pub. Date: Jul. 31, 2014

(54) System and Method for Optimizing Collections Processing

(71) Applicant: Opera Solutions, LLC, Jersey City, NJ (US)

(72) Inventors: Kathleen Crowe, San Diego, CA (US); Arun Ravindran, Del Mar, CA (US); Richard Williams, Jersey City, NJ (US); Cecile Levasseur, La Jolla, CA (US); Jenny Guofeng Zhang, San Diego, CA (US)

(73) Assignee: OPERA SOLUTIONS, LLC, Jersey City, NJ (US)

(21) Appl. No.: 14/164,794

(22) Filed: Jan. 27, 2014

Related U.S. Application Data
(60) Provisional application No. 61/756,750, filed on Jan. 25, 2013.

(51) Int. Cl. G06Q 40/02

(52) U.S. Cl. CPC G06Q 40/02
USPC 705/35

(57) ABSTRACT

A system and method for optimizing collections processing is provided. More specifically, the system for optimizing collections processing comprises a computer system in electronic communication with an accounts database storing customer and account information therein, the computer system executing a collections processing engine, said engine performing the steps of (a) electronically receiving a notification that an account has entered a collections process, (b) defining one or more customer behavior models based on customer and account information stored in the accounts database, (c) processing the customer and account information using the one or more models to calculate one or more model scores representing a probability that the account will pay to current while in a current collections stage having a treatment action associated therewith, (d) processing the calculated one or more model scores to calculate an optimal amount of time that the account should stay in the current collections stage, (e) determining whether to transfer the account to a next collections stage having another treatment action different than the current stage, and (f) repeating steps c-e until full payment is received and removing the account from the collections process.

### CROSS-REFERENCE TO RELATED APPLICATION

This application claims priority to U.S. Provisional Patent Application No. 61/756,750 filed on Jan. 25, 2013, which is incorporated herein in its entirety by reference and made a part hereof.

### BACKGROUND OF THE INVENTION

1. Field of the Invention

The present invention relates generally to a system and method for processing collections based on a customer's estimated risk and/or responsiveness to different treatments. More specifically, the present invention relates to a system and method for optimizing collections processing.

2. Related Art

When a cardholder misses payments and becomes delinquent, the cardholder generally enters collections. Banks contact these debtors using different methods and offer a wide variety of incentives (i.e., treatments) to make debtors pay. For example, some account holders can be contacted immediately, while some can be contacted after an initial delay. In addition, some account holders can be contacted using an auto-dialer (e.g., an automated voice message) to remind the debtor of the payment to be made, while other account holders can be contacted using a live dialer (i.e., a human). The severity of the delinquency will generally vary the treatment (e.g., a reduced interest rate, a partial waiver, litigation, etc.). In general, an account in collections can be considered “an account to be cured” and “paid-to-current” when the customer has paid his dues and/or the minimum dues for a few consecutive months. Balances on accounts that do not make a payment are generally charged-off and/or written-off as a loss, and sold to an external collection agency.

Collections processes currently utilized in the industry (e.g., financial services firms, credit card companies, banks, collection agencies, etc.) generally involve a regimented, rigid, time-dependent approach for collections segmentation. For example, collections processes are generally tightly coupled to “buckets,” cycles past due, and/or stages, and treatments are typically contingent on the buckets. The duration (e.g., the number of days) an account stays in each stage generally remains fixed (e.g., about 30-day blocks). Therefore, customers generally start in bucket 1 (e.g., about 1-29 days past due), and pass through a number of other buckets (e.g., bucket 2, bucket 3, bucket 4, bucket 5, bucket 6, etc.), until they charge-off or become cured at, for example, 180 days past due when entering bucket 7. With the fixed duration of each stage, all accounts generally pass through the same cascade of treatment stages and stay in each stage for substantially the same duration. It is generally not accounted for that some accounts may not respond to particular treatments. Thus, for example, a group of accounts may reach day 87 in collections having passed through the same stages and/or treatments.

FIG. 1 is a diagram of a collections system 10 currently utilized in the industry. As described above, the collections system 10 generally includes buckets 12 of a fixed duration (e.g., bucket 1 16 for 0-30 days passed due (“DPD”), bucket 2 18 for 30-60 DPD, bucket 3 20 for 60-90 DPD, etc.) and various levels/categories of risk 14 (e.g., low/medium, high, and extra high). Each level of risk 14 can be assigned a specific method of collection for each bucket. For example, the low/medium level is assigned a no contact/auto dialer method of collection, the high level is assigned a live dialer method of collection, and an extra high level is assigned a live dialer method of collection for the time period of bucket 1 16. The rigid, bucket-based strategy maintains each account with the originally assigned method of collection for the entire duration of each bucket. Thus, until the end of bucket 1 16, the method of collection for accounts at each level of risk remains as originally assigned.

If any accounts remain in the collections system 10 after the completion of bucket 1 16, all pending accounts are transferred to bucket 2 18, where for all accounts at each level of risk, the method of collection can be upgraded (e.g., live dialer) or kept the same. Thus, the risk categories and/or the method of collection change on a bucket-to-bucket basis (e.g., a monthly basis), such that all accounts remain at their respective level of risk 14 and/or bucket 12 until the end of bucket 2 18. After completion of bucket 2 18, all pending accounts can further be transferred to bucket 3 20, and so on. Due to the rigidity of the collections system 10, low level risk customers may be contacted from day 1, and high level risk accounts (i.e., bad accounts) may linger in the collections system 10 for months before proper action is taken.

FIG. 2 is a diagram illustrating an alternative collections system 30 currently utilized in the industry. The collections system 30 includes buckets 32 for a plurality of banks 34. Each bucket 32 represents a number of days (e.g., 1-29 days for bucket 1 36, 30-59 days for bucket 2 38, 60-89 days for bucket 3 40, 90-119 days for bucket 4 42, 120-149 days for bucket 5 44, 150-179 days for bucket 6 46, etc.). Banks 34 could have separate outbound strategies 50, 54 and 62 (i.e., strategies for contact/calls originated by the bank) and inbound strategies 52, 56 and 64 (i.e., strategies for contact/calls initiated by the customer), or a blend 58 and 60 of outbound strategies and inbound strategies. However, as described above, although the treatment and/or contract strategy in the collection system 30 could vary with each bank 34, the duration of each bucket 32 generally remains fixed.

In other collections systems currently utilized in the industry, some financial firms estimate the probability that an account will result in a charge-off or write-off when they enter collections. If an estimated delinquency level is high, an account could be rolled into later stages in the collections process, but the duration of these later stages are generally still fixed for all accounts. Also, financial institutions (e.g., banks) could have proprietary behavior scores for accounts in collections which can be frequently computed when an account enters collections, rolls from an early stage to a late stage, rolls from one bucket to the next, etc. In general, these scores can be used to identify better treatment options in a specific bucket. Based on these scores, accounts can be grouped by segments. However, people within a segment generally receive similar treatments.

FIGS. 3A-D are diagrams of collections systems 80, 90, 100 and 110 of different financial institutions utilizing proprietary scores to identify optimal treatments. For example, FIG. 3A shows a proprietary score system 80 utilized by Bank A, including an early stage system 82 and a late stage system 84. The early stage system 82 is based on an account balance and a risk score. The late stage system 84 is based on an account balance, days since the last payment, a risk score, and a probability to pay score. The highest risk zone 86 is located at a point correlating with a high account balance, a high days since last payment, a low risk score, and a low probability to pay score. FIG. 3B shows the proprietary score system 90 utilized by Bank G, including a loan system 92 and a card system 94. The loan system 92 is based on an account balance and a collection score. The card system 94 is based on a utilization value, a customer score, and a behavior score. The highest risk zone 96 is located at a point of a high utilization value, a high customer score, and a high behavior score. FIG. 3C shows the proprietary score system 100 utilized by Bank F, including an early stage system 102 and a late stage system 104. The early stage system 102 is based on an account balance and a days past due value. The late stage system 104 is based on an account balance and a probability to collect score. FIG. 3D shows the proprietary score system 110 utilized by Bank H, including a determination system for all accounts 112 based on an account balance and a risk score.

FIG. 4 is a diagram of a collections segmentation scheme 120 showing specifics of the collections segmentation system 80 discussed with respect to FIG. 3A. The collections segmentation scheme 120 generally includes assignment of treatment options to accounts based on a plurality of buckets 122 and a plurality of risk segments 124. Customers can move to different buckets 122 and/or risk segments 124 through, for example, re-aging, intermediate payments, other customer actions, etc. Based on the positioning of the account with respect to buckets 122 and/or risk segments 124, varying methods/strategies of treatment and/or contact could be implemented. However, each bucket 122 generally rigidly maintains the same time period for each account being treated.

FIG. 5 is a diagram of a card collections segmentation scheme 130 showing specifics of the collections segmentation system 90 discussed with respect to FIG. 3B. The card collections segmentation scheme 130 is generally based on cycle, credit utilization, behavior score, tenure, etc. The collection segmentation scheme 130 generally includes buckets of days from first missed payment value 132 (i.e., cycles) and risk segments 134. Various scores (e.g., a customer score, a behavior score, a credit utilization score, a delinquency score, etc.) could be calculated to determine the movement of an account through buckets and/or risk segments 134. However, each bucket generally rigidly maintains the same time period for treating each account.

FIG. 6 is a diagram of a collections segmentation scheme 140 showing specifics of the collections segmentation system 110 discussed with respect to FIG. 3D. The collections segmentation scheme 140 includes buckets 142, treatment decisions 146, and segments 144 (e.g., account balance, risk level, and sensitivity to treatment). For example, the treatment for accounts which are segmented as sensitive to treatment can be intensified after a specific time period, the treatment for accounts which are insensitive to treatment and have a low account balance or accounts with high likelihood-to-pay (LTP) can be de-prioritized after a specific time period, and the treatment for high balance/high risk accounts can be intensified after a specific time period. However, similar to the prior systems discussed, each stage 142 generally rigidly maintains the same time period for treating each account.

As described above, the rigid systems currently utilized in the industry generally group accounts with similar scores by segments and each segment receives similar treatments. Thus, the treatment grids and/or segments currently utilized fail to provide the variability, flexibility, and/or adaptability necessitated by the industry. Thus, a need exists for optimizing a contact and/or treatment strategy for accounts in collections which allow greater flexibility in the timing of soft and/or aggressive collections actions. Further, a need exists for a new variable timing segmentation. These and other needs are satisfied by the systems and methods disclosed herein, which generally implement a customer's estimated risk and/or responsiveness to different treatments to create an optimized collections process.

### SUMMARY OF THE INVENTION

The present invention relates to a system and method for optimizing collections processing. The system is based on customers' estimated risk and/or responsiveness to different treatments. The system includes entering an account into a collections stage, defining statistical models to predict customer behavior, and determining the time an account should stay in a specific collections stage and whether the account should be transferred to the next collections stage. Based on this determination, the account can leave the collections stage after a full payment is received, the account can be kept in a specific collections stage, or the account can be transferred to the next collections stage.

### BRIEF DESCRIPTION OF THE DRAWINGS

The foregoing features of the invention will be apparent from the following Detailed Description of the Invention, taken in connection with the accompanying drawings, in which:

FIGS. 1-2 are diagrams of collections systems currently utilized in the industry;

FIGS. 3A-3D are diagrams of collections systems of the prior art of different financial institutions utilizing proprietary scores to identify optimal treatments;

FIG. 4-6 are diagrams showing specifics of detailed collections systems of the prior art of FIGS. 3A, 3B, and 3D, respectively;

FIG. 7 is a flowchart showing overall processing steps of an optimized collections processing system;

FIG. 8 is a diagram of successive stages characteristic of a variable timing collections process;

FIG. 9 is a diagram showing steps for defining a set of models for a system for incorporating knowledge and/or information from previous stages;

FIG. 10 is a diagram of a segmentation system of the present invention; and

FIG. 11 is a diagram showing hardware and software components of a computer system capable of performing the processes of the present invention.

### DETAILED DESCRIPTION OF THE INVENTION

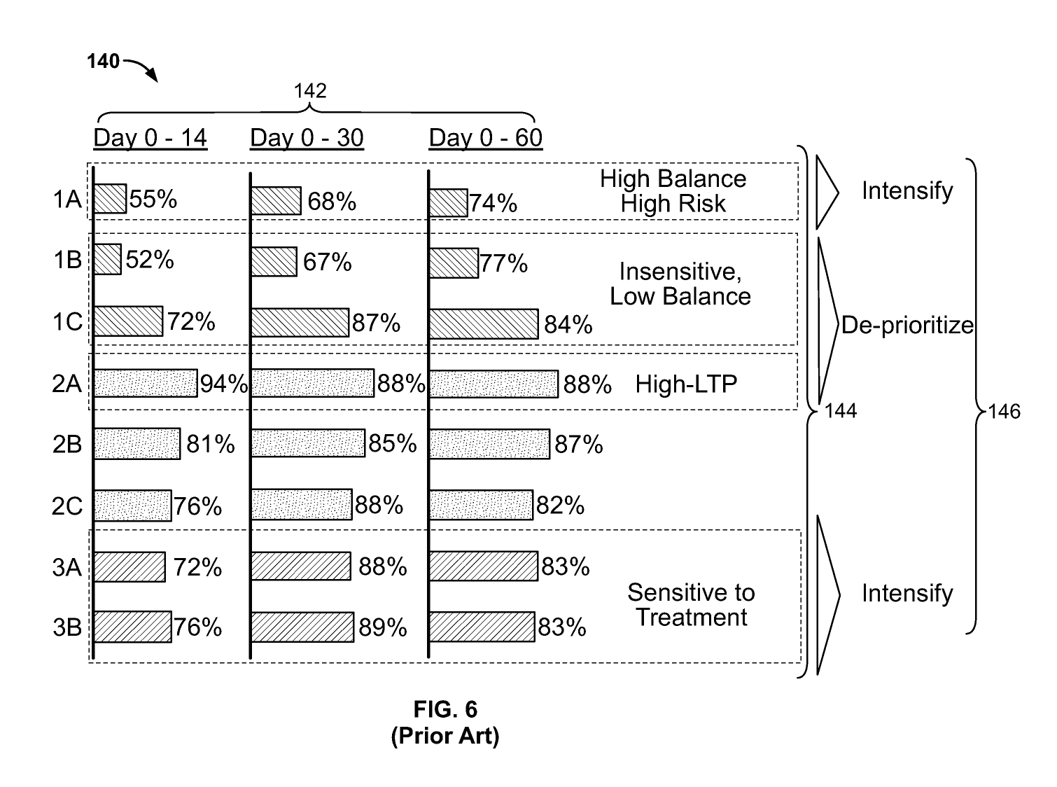

The present invention relates to a system and method for optimizing collections processing based on customers' estimated risk and/or responsiveness to different treatments, as discussed in detail below in connection with FIGS. 7-11.

The variable timing segmentation system of the present invention discussed herein has removed the rigid and time-bound structure of the existing collections segmentation approaches currently utilized in the industry and replaced them with a more flexible and/or adaptable approach to transfer accounts into the right channel/segment and/or stage as quickly as possible. The system implements stages to track the flow of accounts through the life-cycle, and optimizes at an account level the time spent in each stage of the collections process. The collections system described herein could be implemented to improve the contact and/or treatment strategy for any type of agency which utilizes a collections process. Compared to the rigid and/or time-dependent systems in place today, the system allows much greater flexibility in the duration and/or timing of soft and/or aggressive collections actions based on each customer's estimated risk and/or responsiveness to different treatments, among other factors. Still further, the collections system discussed herein reduces the cost of collections. In particular, approximately 90% of accounts can generally be cured without human intervention. The collections system could increase the amount of time customers are permitted to self-cure, while honing collector efforts on those accounts that are least likely to self-cure. Thus, a reduction of resources used for accounts most and least likely to pay back their debt can be implemented, while a better allocation of resources and/or treatment decisions for accounts needing more critical care can be provided. The customer experience in collections is also improved. For example, although the majority of accounts currently result in collection by a collector at some point in their life-cycle, the collections systems could permit the majority of customers to be excluded from the intense and/or more aggressive collections stages.

FIG. 7 is a flowchart showing overall processing steps 200 carried out by the optimized collections processing system. Beginning in step 202, the system receives notification that an account has entered the collections process and an initial collections stage, although the initial collections stage could be assigned at a later step in the process. Next, in step 204, statistical models (e.g., customer behavior models 206) are selected based on account features and timing, and then one or more model scores/dimensions are calculated using a collections engine. Information contained about the customer and the account is stored in the accounts database 207, and such information is utilized to define the models 206 (e.g., the account balance is used as an input for the models). Customer behavior models 206 could include a model 208 of the risk of the account, a model 210 of the ability of the customer to pay to current, and/or a model 212 of the responsiveness of the customer to different treatments. The models generally utilize a days in collections value (i.e., how long an account has been in collections), rather than using days past due as a variable, which typically prevents rolling from one stage to the next.

The collections process could be a succession of N consecutive stages, where each stage is assigned or associated with a treatment, and an account in collections is assigned to a stage in the accounts database. These stages could be ordered by treatment severity, with the last stage generally being litigation. For example, the first stage could correspond to a no-contact stage, during which the account owner is not contacted or bothered to give allowance for people who forgot to pay. Customers who do not pay in the first stage could receive an automated message from an auto-dialer, a call from a live-dialer, etc. These contact methods can vary in type and/or intensity depending on the dialer strategy. Live-dialers can evaluate the customer's predicament and offer one of many payment plans (i.e., treatments) that they deem appropriate. For customers who do not respond to previous treatments, legal action could be an option. In step 214, a determination is made as to whether the account should be transferred to the next collections stage. If so, then the account is transferred to the next stage in step 216, and then returns to step 204. When transferred, the accounts database is updated, and the treatment could be automatically executed by the system (e.g., auto-dialer), or one or more users could be automatically notified of the transfer (e.g., text, email, etc.). For example, the system could instruct an auto-dialer and/or an interactive voice response (IVR) system to automatically place a telephone call to the account holder to request payment of the account. Further, the system could be programmed to automatically transmit an e-mail, text, or other form of electronic communication to the account holder, to request payment of the account. If not, the account is kept in the current stage in step 218. In step 220, the optimal amount of time the account should stay in (i.e., be assigned to) the current collections stage is calculated using one or more of the calculated model scores. The system calculates the optimal number of days for each treatment towards paying to current, as opposed to just the first payment (i.e., any payment, either full or partial), as used and predicted by some financial institution models.

Then, in step 222, a determination is made as to whether full payment has been received. If not, the process proceeds to step 223, where a determination is made as to whether there has been a significant event. If not, the process proceeds to step 224, where a determination is made as to whether the calculated optimal time has elapsed. If the optimal time has not elapsed, the process returns to step 222. If there has been a significant event in step 223, or if the optimal time has elapsed in step 224, then the process proceeds to step 226. In step 226 the accounts database 207 is updated with any new collections processing information (e.g., responsiveness to treatment, discovery that customer is paying other creditors, increase of external balances, payments, etc.), and then returns to step 204. If, in step 222, the full payment has been received, the process proceeds to step 230 where the account is removed from the collections stage and the collections process, and the accounts database is updated accordingly. In this way, an account could progress through various collections stages until a full payment has been received from the customer.

The system could also utilize various segments and assign an account to an appropriate segment, such as by processing the one or more model scores. In this way, each segment could have its own order of stages through which an account could be processed. The segments could be risk segments, so that, for example, an account is placed in a particular risk segment depending on the score of the risk of the account model. Additionally, the risk segment of an account could be re-assigned every time the system calculates, or recalculates one or more model scores.

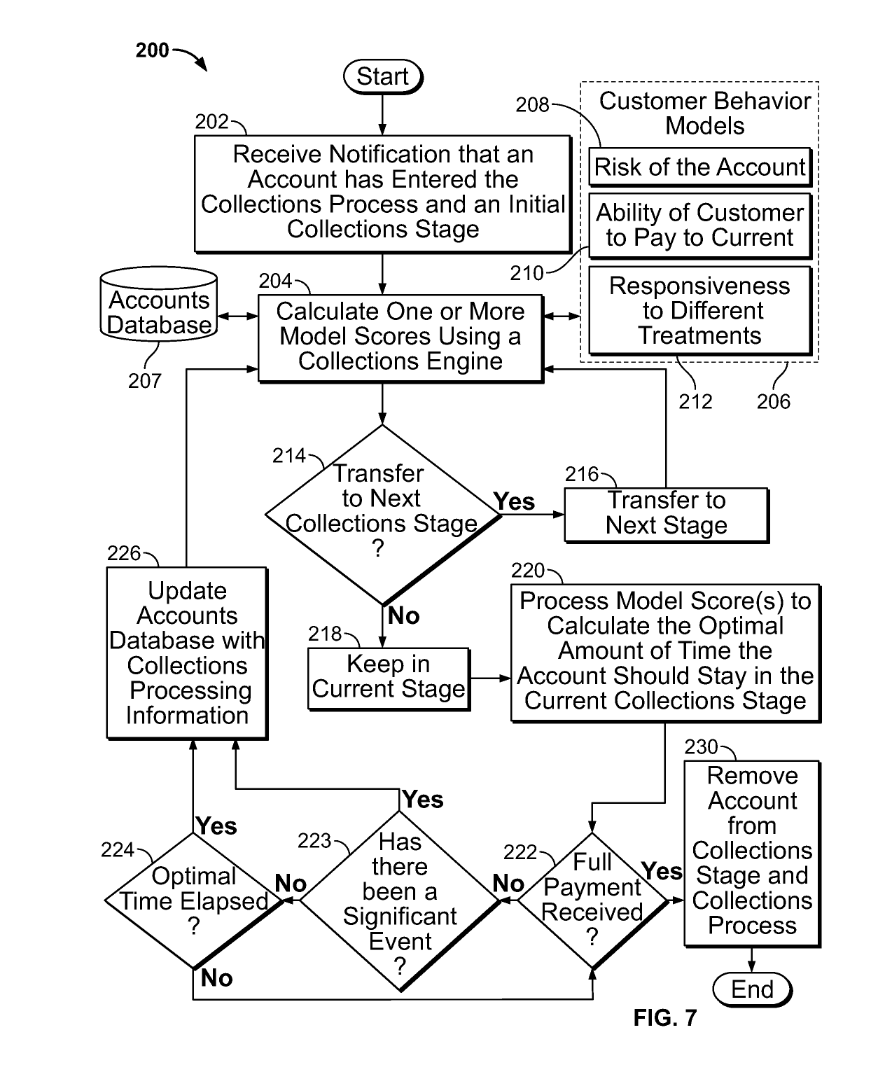

FIG. 8 is a diagram of successive stages characteristic of a variable timing collections process 300, consistent with that described above with FIG. 7. For an account transferring from stage i−1 (e.g., first stage 302), and entering stage i (e.g., second stage 304), the system determines how long (e.g., how many days) the account should be kept in the first stage 302. Once an account enters the second stage 304, the account could stay in the second stage 304 until the full debt has been paid and received and is then removed from the collections process 300, or alternatively, not pay the debt and stay in the second stage 304 until the end of the time period allocated by the system, and then move on to stage i+1 (e.g., the third stage 306). At each stage of the collections process 300, if the customer pays the debt in full, the account could be removed as indicated by arrows 308, 312 or 316. Similarly, at each stage of the collections process 300, an optimization of how long an account should be in each stage, as indicated by arrows 310, 314 and 318, could be made by predicting how responsive the customer is likely to be for the treatments in the specific stage.

As mentioned above, in order to optimally allocate the time an account should spend in a particular stage, statistical models could be defined to predict customer behavior. The statistical models could predict how risky the customer is, the ability of the customer to pay to current, etc. Thus, these models predict customer behavior when the customer's account enters each stage of the collections process. In some embodiments, for each stage of the collections process, models can be trained to estimate the probability (i.e., model score) that an account will pay to current (e.g., account holder pays his/her debt in full, pays three or more consecutive minimum payment dues on time, etc.) while in a particular stage, estimate the probability that the account will go bad once entering a particular stage, etc.

For example, one statistical model, P(Bad|Enter i), could represent the probability that an account will go bad once having entered a specific stage i. Another statistical model, P(Pay To Current|Enter i), could represent the probability that an account will pay to current after entering a specific stage i. If an account scores high on the P(Bad|Enter i) model, the collections system could avoid keeping the account in stage i for a long period of time, thus the number of days allocated to stage i could be low. Similarly, if the account scores high on the P(Pay To Current|Enter i) model, the account could be worth leaving in stage i for a longer period of time, thus the number of days allocated to stage i could be high. On the contrary, if the account scores low on the P(Pay To Current|Enter i) model, the account could be moved to the next stage in a shorter period of time. If the account scores very low on the P(Pay To Current|Enter i) model, this implies that the treatments in this stage are ineffective and the account should be transferred to the next stage in the collection system. Thus, for each account, the models can predict customer behavior on entering, or before entering, a stage. The predicted customer behavior can further be utilized to determine the effectiveness of treatments in the specific stage, thereby determining how long the account should be kept in a stage.

The mapping from model scores to optimal number of days could be done using several methods. Policy constraints which determine the maximum and/or minimum permissible number of days an account can stay in a particular stage could be given as boundary conditions. One approach could be to bin the scores (e.g., by deciles or quartiles) from all models in each stage and calculate the average time to pay for each bin during the model building phase. Another approach could be to utilize survival analysis methods which predict life spans of biological organisms and failure in mechanical systems. These methods can be used to estimate the cost associated with the allotted number of days in each stage, thus further optimizing the process. By fitting a time to pay probability distribution (e.g., a Weibull distribution) the chances of a customer paying to current, given a particular number of days, can be calculated. A similar distribution could further be fitted for the “time-to-go-bad” model. The process settings further allow for integration of sets of constraints (e.g., regulatory issues) generally imposed by financial services firms. For example, a policy could impose that an account entering collections not be contacted until at least five days into the collections process. This rule could be incorporated in the time allocation optimization process described herein, thereby providing greater flexibility in the implementation of the process.

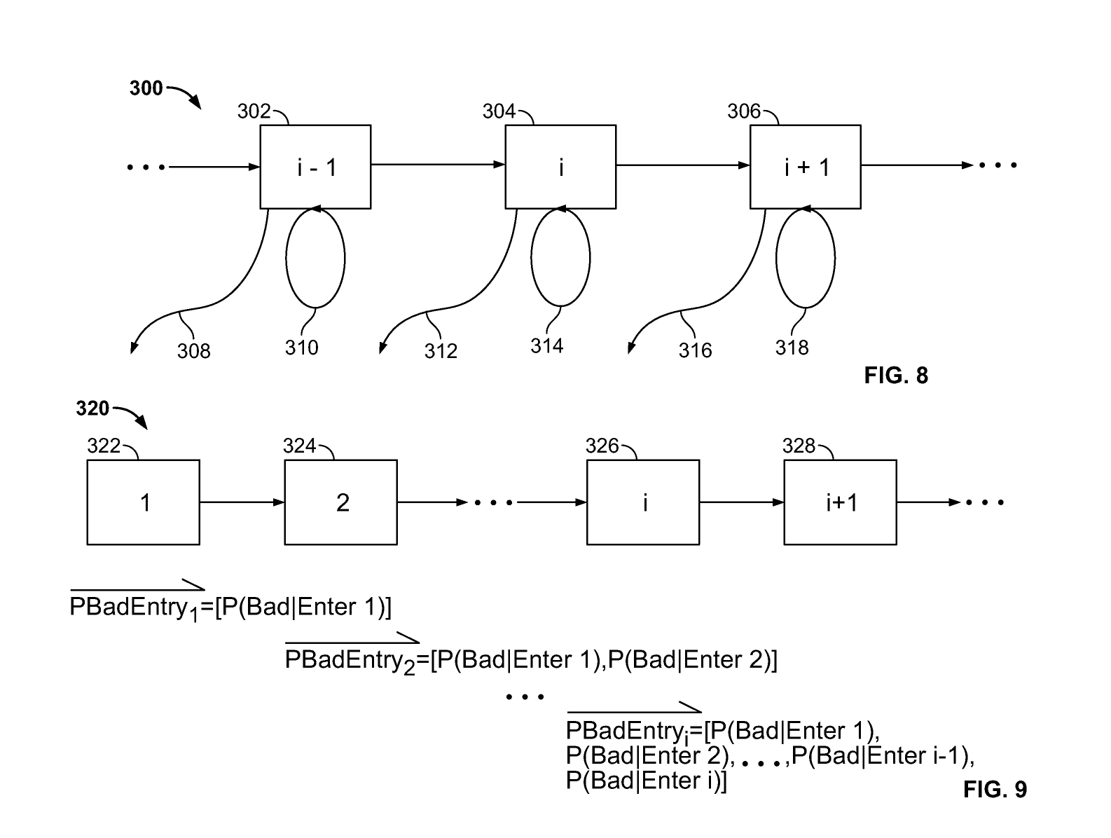

As mentioned above, the account holder's circumstances or history, and/or information collected at previous stages could be stored in an accounts database and utilized by the system. FIG. 9 is a diagram showing steps for defining a set of models for a system 320 for incorporating knowledge and/or information from previous stages. More specifically, FIG. 9 shows a first stage 322, a second stage 324, a subsequent stage i 326, and another subsequent stage i+1 328. The model for the first stage 322 could be represented as:

PBadEntry₁=[P(Bad|Enter 1)] Equation 1

The model for the second stage 354 could be represented as:

PBadEntry₂=[P(Bad|Enter 1), P(Bad|Enter 2)] Equation 2

thereby taking into account the information collected from both the first and second stages 322 and 324. The stage i 326 model could be represented as:

PBadEntryᵢ=[P(Bad|Enter 1), P(Bad|Enter 2), . . . , P(Bad|Enter i−1), P(Bad|Enter i)] Equation 3

thereby taking into account the information collected from any and all stages between the first stage 322 and stage i 326. Similarly, the model for stage i+1 328 could be represented as:

PBadEntryᵢ₊₁=[P(Bad|Enter 1), P(Bad|Enter 2), . . . , P(Bad|Enter i), P(Bad|Enter i+1)] Equation 4

thereby taking into account the information collected from any and all stages between the first stage 322 and stage i+1 328. Thus, an account entering stage i+1 328 could be scored by the estimated models and with knowledge gained from the previous stages, thereby optimizing the timing of the account in stage i+1 328.

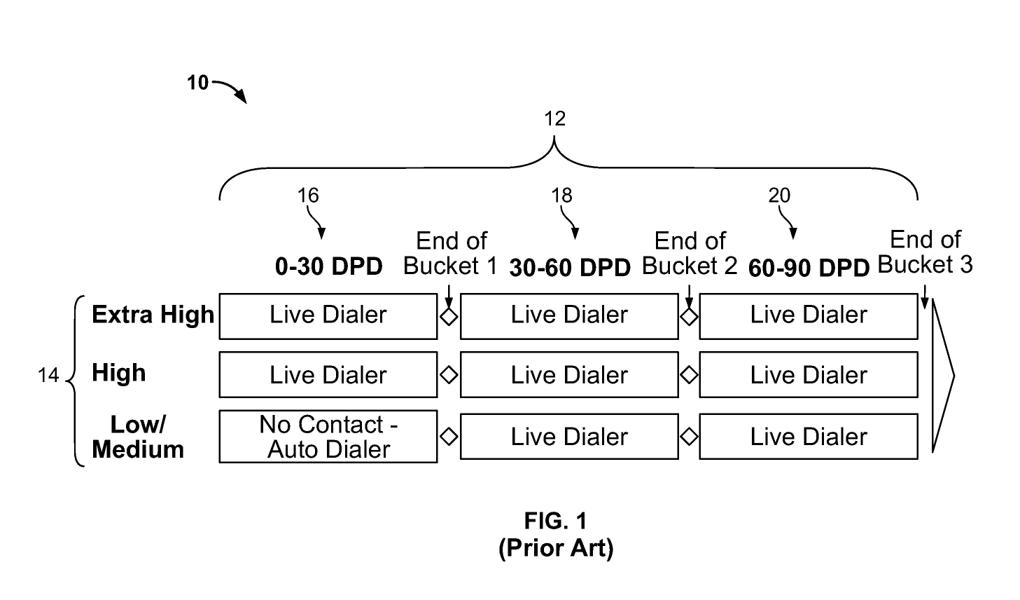

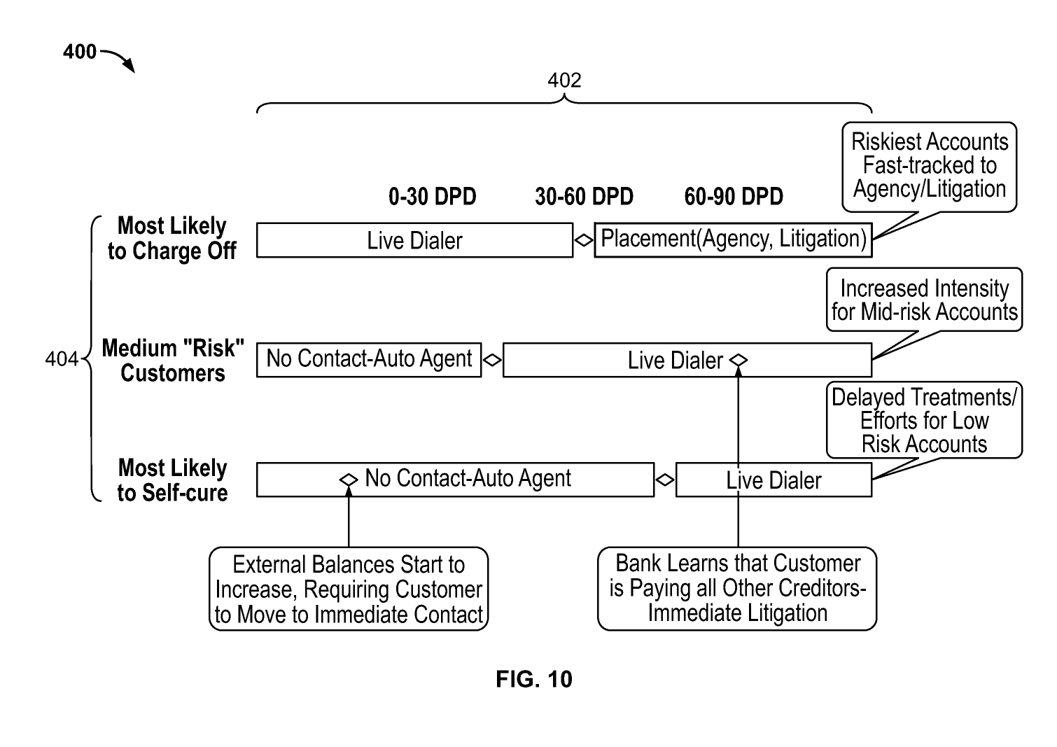

FIG. 10 is a diagram of a segmentation system 400 that could be used with the variable timing scheme of the present invention. In particular, FIG. 10 illustrates the flexibility of the segmentation system 400 with a variable timing system as compared to the collections system 100 discussed with respect to FIG. 1. The segmentation system 400 includes a measurement of time periods 402 (i.e., stages) and levels of risk 404 (e.g., most likely to self-cure, medium risk customers, most likely to charge off, etc.). In this way, the initial collections stage of the processing steps described above with respect to FIG. 7 would vary depending on the calculated risk of the account. The flexibility of the segmentation system 400 using the variable timing scheme allows accounts to be transferred between, for example, stages, treatments, levels of risk 404, etc., based on the specific characteristics of each account, thereby creating a customized collections system for each account. In particular, the segmentation system 400 is not time bound and the transition from one stage to another can be done as quickly or as slowly as needed on an account level. For example, accounts more likely to cure without any contact can remain in the no-contact stage longer than riskier accounts that are more likely to charge off. If an account is at a high risk of charge off, the no-contact stage could be abandoned altogether, and the account could be moved to a high contact strategy stage.

The accounts in the most likely to self-cure and medium risk customer categories could incur treatments of, for example, no contact, auto agent, live dialer, etc., implemented at various time stages based on the account being treated. In particular, the most likely to self-cure category generally receives delayed treatments and/or efforts for low risk accounts with the expectation that the account will be self-cured. If, for example, an external balance starts to increase for an account in the no contact and/or auto agent treatment phase, the customer could be transferred to an immediate contact treatment phase to ensure the balance is timely paid. The medium risk customer accounts generally receive increased intensity for mid-risk accounts. For example, a medium risk customer account could receive the no contact and/or auto agent treatment for a shorter period of time than the most likely to self-cure account and could receive the live dialer treatment for a longer period of time. If, for example, a creditor learns that a customer in the live dialer treatment phase is paying all other creditors while not making any payments to the creditor of interest, an intensified treatment could be applied (e.g., litigation) to ensure timely payment is received. The accounts in the most likely to charge-off category could incur treatments of, for example, live dialer, placement (e.g., outside agency, litigation), etc. In particular, the most likely to charge-off accounts are generally the riskiest accounts which are fast-tracked to agency and/or litigation. Thus, the most likely to charge-off accounts could initially receive a live dialer treatment and could further be placed with an agency and/or in litigation as an intensified treatment.

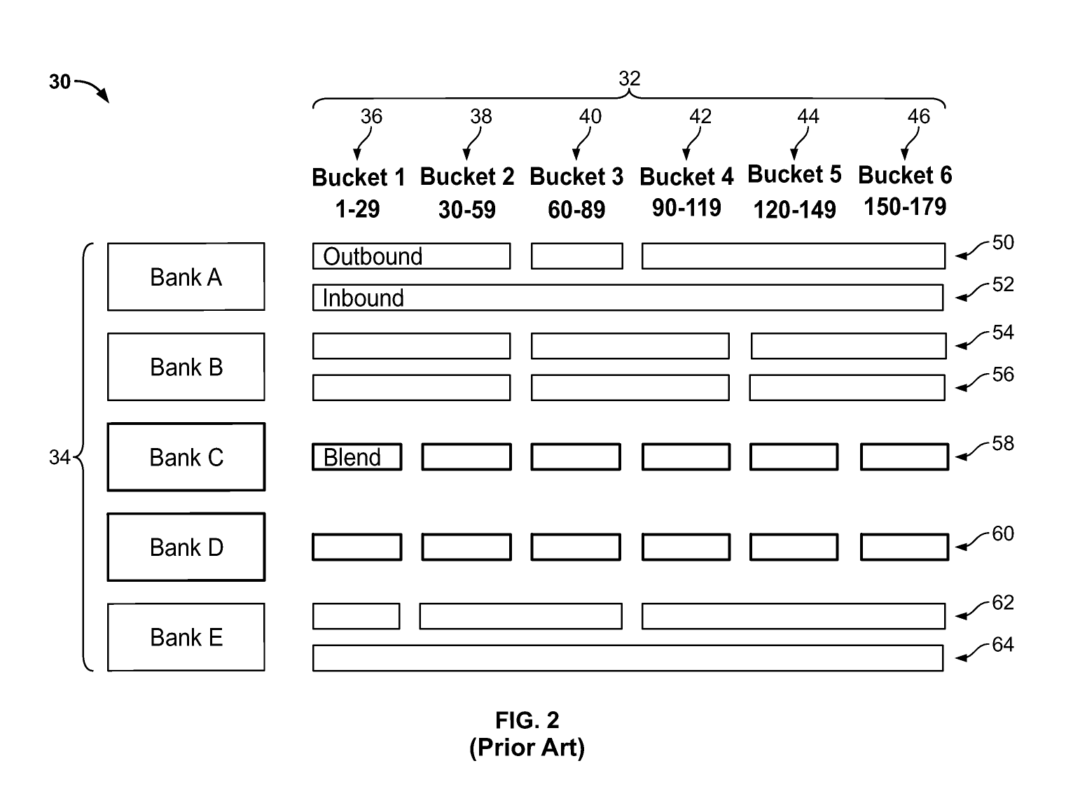

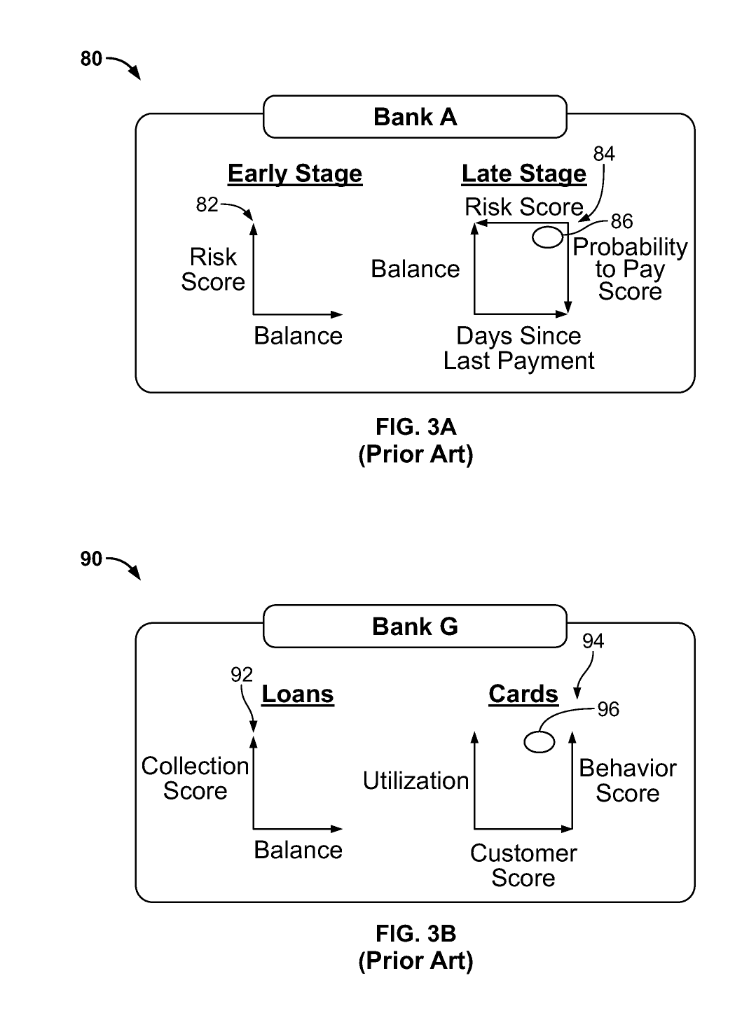

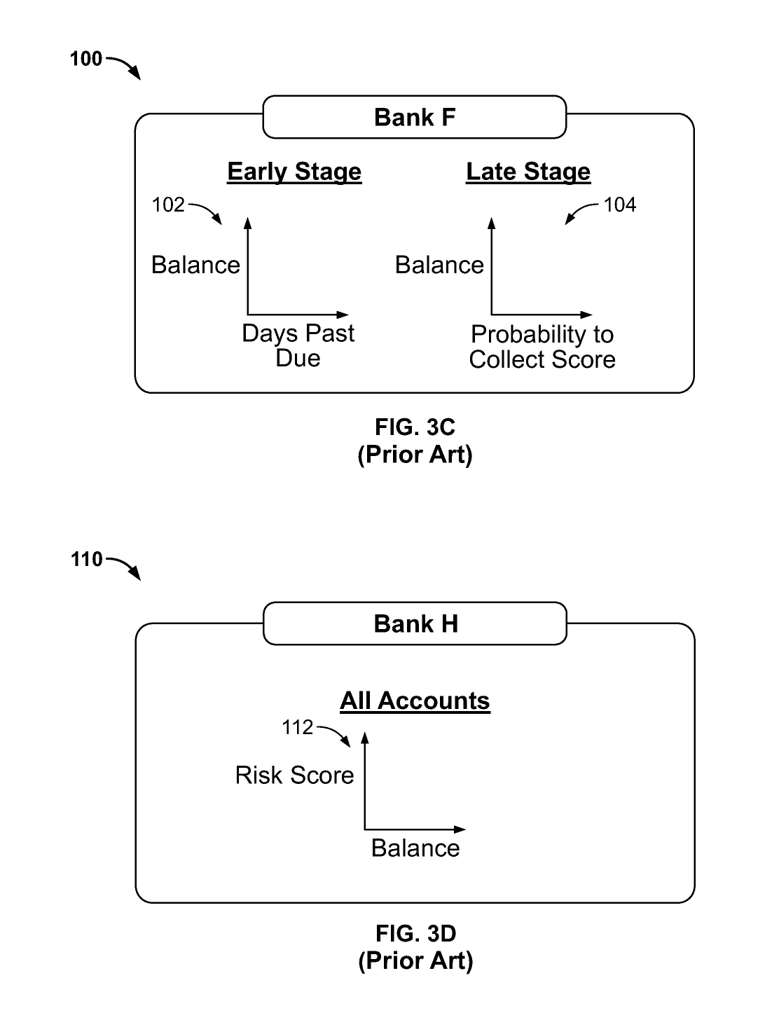

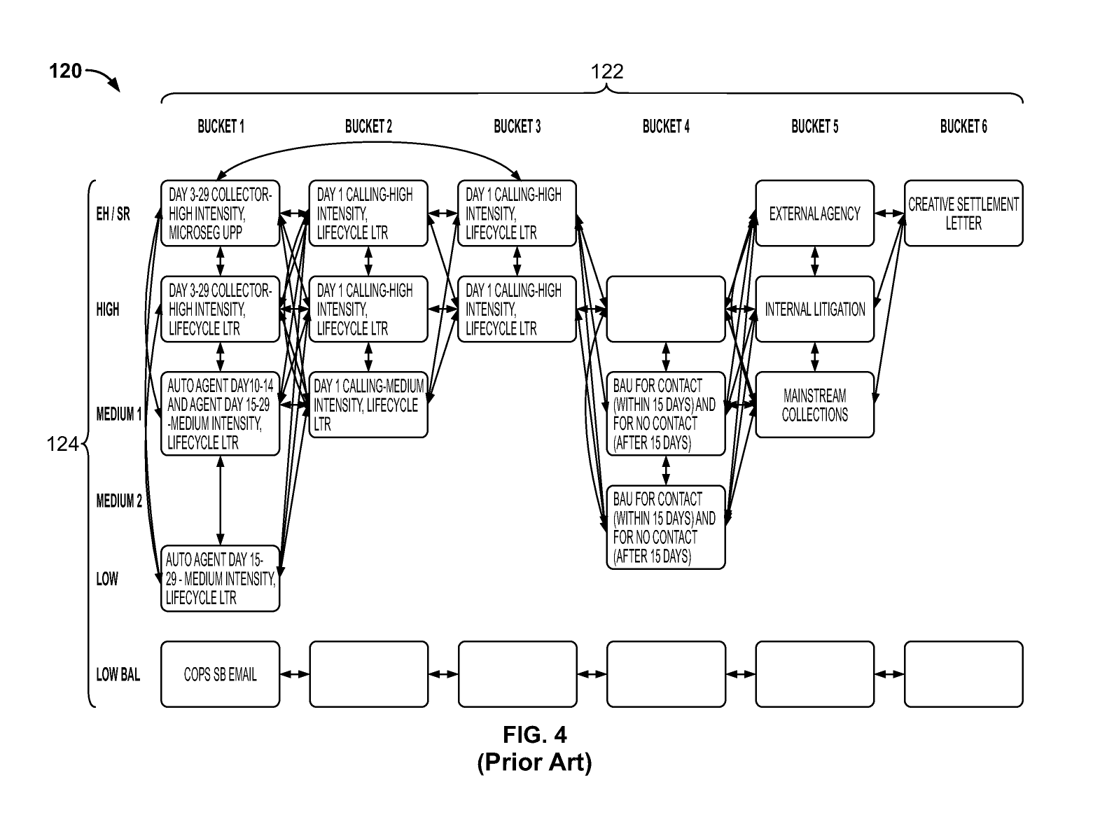

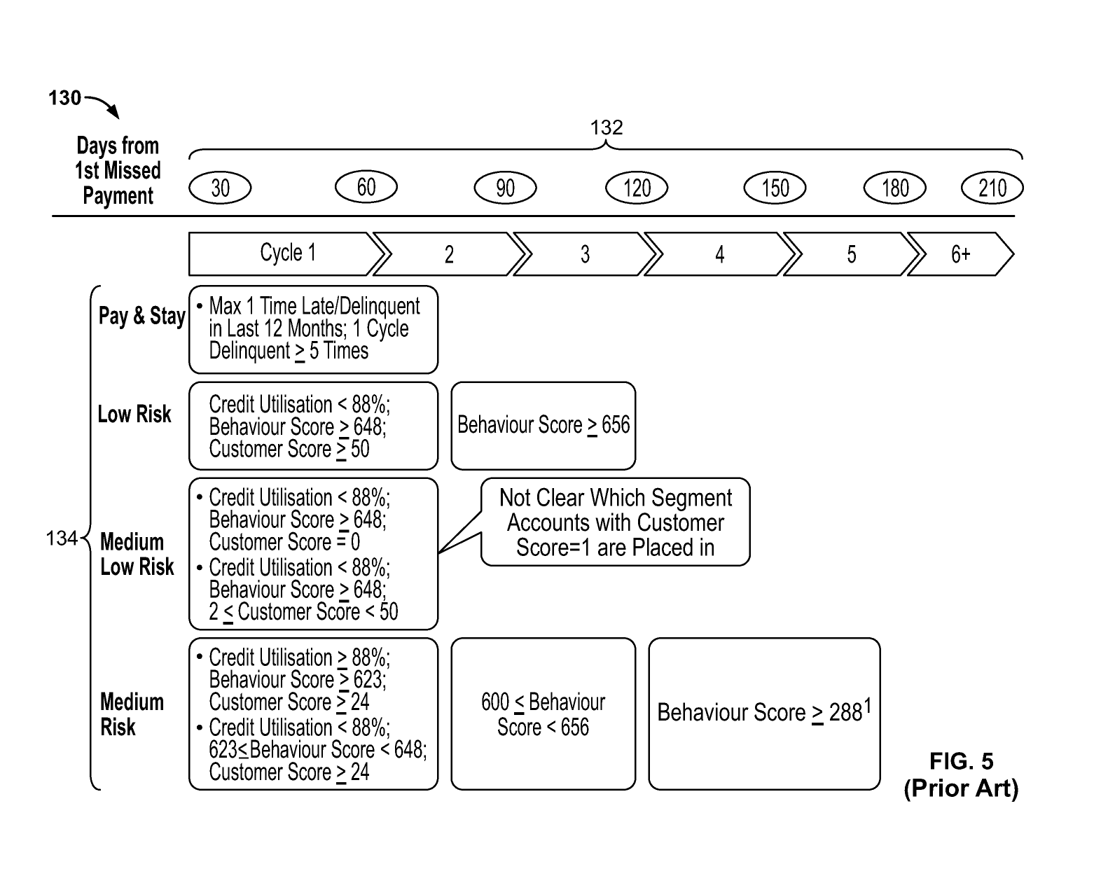

Similarly, the variable timing scheme and segmentation scheme of the system of the present invention could be implemented with respect to the systems of FIGS. 2-6 currently implemented in the industry. In particular, rather than the rigid approach of the systems discussed in FIGS. 2-6, including the fixed time duration and/or segments for accounts which receive similar treatments, the system could be implemented to use treatment grids and/or segments with variable treatment timing based on characteristics of the specific account being treated. Thus, the various accounts being treated can be transferred between levels of risk and/or methods of treatment at differing time periods based on, for example, actions of the customer, and the like. In some embodiments, extended low contact stages could be implemented, such as for customers that are more likely to pay without any contact (e.g., accidental delinquents). Accelerated late stage actions could be implemented in some embodiments for accounts that have a high likelihood of going bad. In particular, these accounts could be accelerated to more aggressive contact strategies and/or treatments after a period of time. The stages an account is processed through could vary by risk segmentation.

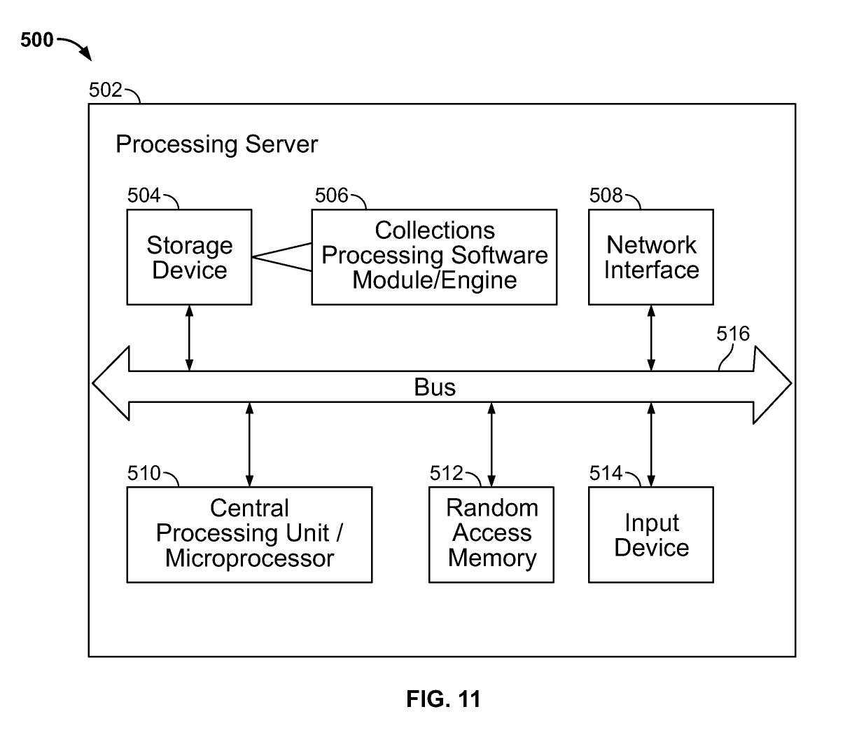

FIG. 11 is a diagram showing hardware and software components of a system 500 capable of performing the processes discussed above. The system 500 includes a processing server 502, e.g., a computer, and the like, which can include a storage device 504, a network interface 508, a communications bus 516, a central processing unit (CPU) 510, e.g., a microprocessor, and the like, a random access memory (RAM) 512, and one or more input devices 514, e.g., a keyboard, a mouse, and the like. The processing server 502 can also include a display, e.g., a liquid crystal display (LCD), a cathode ray tube (CRT), and the like. The storage device 504 can include any suitable, computer-readable storage medium, e.g., a disk, non-volatile memory, read-only memory (ROM), erasable programmable ROM (EPROM), electrically-erasable programmable ROM (EEPROM), flash memory, field-programmable gate array (FPGA), and the like. The processing server 502 can be, e.g., a networked computer system, a personal computer, a smart phone, a tablet, and the like.

The present invention can be embodied as a collections processing software module and/or engine 506, which can be embodied as computer-readable program code stored on the storage device 504 and executed by the CPU 510 using any suitable, high or low level computing language, such as, e.g., Java, C, C++, C#, .NET, and the like. The network interface 508 can include, e.g., an Ethernet network interface device, a wireless network interface device, any other suitable device which permits the processing server 502 to communicate via the network, and the like. The CPU 510 can include any suitable single- or multiple-core microprocessor of any suitable architecture that is capable of implementing and/or running the collections processing software 506, e.g., an Intel processor, and the like. The random access memory 512 can include any suitable, high-speed, random access memory typical of most modern computers, such as, e.g., dynamic RAM (DRAM), and the like.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention. What is desired to be protected is set forth in the following claims.

What is claimed is:

1. A system for optimizing collections processing comprising:
a computer system in electronic communication with an accounts database storing customer and account information therein, the computer system executing a collections processing engine, said engine performing the steps of:
a. electronically receiving a notification that an account has entered a collections process;
b. defining one or more customer behavior models based on customer and account information stored in the accounts database;
c. processing the customer and account information using the one or more models to calculate one or more model scores representing a probability that the account will pay to current while in a current collections stage having a treatment action associated therewith;
d. processing the calculated one or more model scores to calculate an optimal amount of time that the account should stay in the current collections stage;
e. determining whether to transfer the account to a next collections stage having another treatment action different than the current stage; and
f. repeating steps c-e until full payment is received and removing the account from the collections process.

2. The system of claim 1, wherein the customer behavior models include at least one of a model of a risk of an account, a model of an ability of a customer to pay to current, and a model of a responsiveness of a customer to different treatment actions.

3. The system of claim 1, further comprising assigning the account to an initial collections stage of one of a plurality of segments, wherein each of the plurality of segments has its own order of collections stages through which an account is processed.

4. The system of claim 1, wherein each consecutive collections stage increases treatment action severity.

5. The system of claim 1, further comprising monitoring whether the account has been paid in full.

6. The system of claim 1, further comprising monitoring whether a significant event has occurred.

7. The system of claim 1, further comprising monitoring whether the calculated optimal time has elapsed.

8. The system of claim 7, further comprising transferring the account to a next collections stage if the calculated optimal amount of time has elapsed.

9. The system of claim 1, further comprising updating the accounts database when the account transfers to the next collections stage.

10. The system of claim 1, further comprising automatically notifying the customer of transfer to the next collections stage.

11. A method for optimizing collections processing comprising the steps of:
a. electronically receiving at a collections processing engine of a computer system a notification that an account has entered a collections process, the computer system in electronic communication with an accounts database storing customer and account information therein;
b. defining by the computer system one or more customer behavior models based on customer and account information stored in the accounts database;
c. processing by the computer system the customer and account information using the one or more models to calculate one or more model scores representing a probability that the account will pay to current while in a current collections stage having a treatment action associated therewith;
d. processing by the computer system the calculated one or more model scores to calculate an optimal amount of time that the account should stay in the current collections stage;
e. determining by the computer system whether to transfer the account to a next collections stage having another treatment action different than the current stage; and
f. repeating steps c-e until full payment is received and removing the account from the collections process.

12. The method of claim 11, wherein the customer behavior models include at least one of a model of a risk of an account, a model of an ability of a customer to pay to current, and a model of a responsiveness of a customer to different treatment actions.

13. The method of claim 11, further comprising assigning the account to an initial collections stage of one of a plurality of segments, wherein each of the plurality of segments has its own order of collections stages through which an account is processed.

14. The method of claim 11, wherein each consecutive collections stage increases treatment action severity.

15. The method of claim 11, further comprising monitoring whether the account has been paid in full.

16. The method of claim 11, further comprising monitoring whether a significant event has occurred.

17. The method of claim 11, further comprising monitoring whether the calculated optimal time has elapsed.

18. The method of claim 17, further comprising transferring the account to a next collections stage if the calculated optimal amount of time has elapsed.

19. The method of claim 11, further comprising updating the accounts database when the account transfers to the next collections stage.

20. The method of claim 11, further comprising automatically notifying the customer of transfer to the next collections stage.

21. A computer-readable medium having computer-readable instructions stored thereon which, when executed by a computer system, cause the computer system to perform the steps of:
a. electronically receiving at a collections processing engine of the computer system a notification that an account has entered a collections process, the computer system in electronic communication with an accounts database storing customer and account information therein;
b. defining by the computer system one or more customer behavior models based on customer and account information stored in the accounts database;
c. processing by the computer system the customer and account information using the one or more models to calculate one or more model scores representing a probability that the account will pay to current while in a current collections stage having a treatment action associated therewith;
d. processing by the computer system the calculated one or more model scores to calculate an optimal amount of time that the account should stay in the current collections stage;
e. determining by the computer system whether to transfer the account to a next collections stage having another treatment action different than the current stage; and
f. repeating steps c-e until full payment is received and removing the account from the collections process.

22. The computer-readable medium of claim 21, wherein the customer behavior models include at least one of a model of a risk of an account, a model of an ability of a customer to pay to current, and a model of a responsiveness of a customer to different treatment actions.

23. The computer-readable medium of claim 21, further comprising assigning the account to an initial collections stage of one of a plurality of segments, wherein each of the plurality of segments has its own order of collections stages through which an account is processed.

24. The computer-readable medium of claim 21, wherein each consecutive collections stage increases treatment action severity.

25. The computer-readable medium of claim 21, further comprising monitoring whether the account has been paid in full.

26. The computer-readable medium of claim 21, further comprising monitoring whether a significant event has occurred.

27. The computer-readable medium of claim 21, further comprising monitoring whether the calculated optimal time has elapsed.

28. The computer-readable medium of claim 27, further comprising transferring the account to a next collections stage if the calculated optimal amount of time has elapsed.

29. The computer-readable medium of claim 21, further comprising updating the accounts database when the account transfers to the next collections stage.

30. The computer-readable medium of claim 21, further comprising automatically notifying the customer of transfer to the next collections stage.
